(19) United States
(12) Patent Application Publication
(10) Pub. No.: US 2025/0291879 A1
(43) Pub. Date: Sep. 18, 2025

(54) FEATURE EXTRACTION FROM TIME-BASED TRANSITION EVENTS

(71) Applicant: Analog Devices International Unlimited Company, Co. Limerick (IE)

(72) Inventor: Eoin Seamus Bolger, Co. Kilkenny (IE)

(21) Appl. No.: 18/862,847

(22) PCT Filed: May 6, 2022
(86) PCT No.: PCT/EP2022/062366

§ 371 Date: Nov. 4, 2024

(51) Int. Cl. G06F 17/18

(52) U.S. Cl. CPC G06F 17/18

(57) ABSTRACT

A first signal is obtained. the first signal comprising a transition event having a transition start point. A first transformed signal is determined such that the first transformed signal is indicative of a rate of change of the first signal. A first envelope is calculated based on a substantially stationary portion of the first transformed signal. The transition start point is identified within the first signal based on a point in time where the first transformed signal crosses the first envelope. A command can be issued to an external device based on the transition starts point.

### FIELD OF INVENTION

The present disclosure relates to extracting transition event features from time-series signals. Particularly, but not exclusively, the present disclosure relates to systems and methods for identifying a transition start point from a time-series signal comprising a transition event; more particularly, but not exclusively, the present disclosure relates to identifying a transition start point within a time-series signal to reduce the time in which a sensing apparatus is exposed to an unknown fluid.

### BACKGROUND

A time-series, or time-series signal, is a sequence of time-indexed observations obtained over a period, or interval, of time. The sequence of observations will typically relate to a single entity. For example, measurements periodically taken from a sensor over an interval of time form a time-series signal whereby each observation within the time-series signal corresponds to a measurement obtained from the sensor at a given time point.

Time-series analysis describes a suite of techniques for processing and analysing time-series signals. One important aspect of time-series analysis is the extraction of key features from a time-series signal. Such features can be statistical in nature, such as the average value, the standard deviation, or the periodicity of a time-series signal. Such features can also relate to specific events or time points within the time-series. For example, an outlier observation or an observation having a specific characteristic. When the time-series signal captures a transition event, an important feature to be identified from the time-series signal is the start point, or deviation point, of the transition event. Here, a transition event is understood as an underlying change of state of the entity being measured. Time-series signals comprising transition events are common within many different applications, particularly within applications whereby the time-series signal represents measurements repeatedly taken from a sensing device.

Existing approaches to deviation point detection can be broadly classified as either supervised or unsupervised approaches. Supervised approaches utilise historical data to train an algorithm, such as an artificial neural network, to find each state boundary. A sliding window moves through the data, considering each possible difference between two data points as a possible deviation point. Unsupervised approaches identify patterns in the data without training. Typically, unsupervised approaches are used to segment time-series data, thus finding deviation points based on statistical features of the data.

Such prior approaches are designed for stationary time-series data, where the statistical properties of the time-series are all constant over time. However, time-series data from many real-world applications, such as data obtained from sensing devices as mentioned above, are inherently non-stationary. That is, the data has trends, cycles, random walks, or a combination of all three, such that the statistical properties of the time-series vary over time. This non-stationarity can inhibit the effectiveness of prior art approaches and limit their applicability within real-world settings.

### SUMMARY OF INVENTION

In the present disclosure, a signal comprising a transition event is transformed to a transformed signal indicative of a rate of change of the signal. An envelope is calculated based on a substantially stationary portion of the transformed signal. The start point of the transition event is identified within the signal based on a point in time where the transformed signal crosses the envelope.

The present disclosure provides a method and device for identifying a deviation point within a time-series signal. A first time-series signal is obtained. The first time-series signal has a first sequence of data points within a time window and comprises a transition event having a deviation point. A second time-series signal is determined, the second time-series signal having a second sequence of data points within the time window. The second time-series signal is indicative of a rate of change of the first time-series signal. A substantially stationary portion of the second time-series signal is obtained. An envelope, defined across the time window, is calculated based on the substantially stationary portion of the second time-series signal. The deviation point is identified within the first time-series signal based on a point in time where the second time-series signal crosses the envelope.

As such, aspects of the present disclosure allow accurate and efficient identification of the start of a transition event within a time-series signal. This efficiency allows the method of the present disclosure to be deployed on edge devices where processing and memory resources are limited. Moreover, the accurate determination of the start of a transition event within a time-series signal can allow more precise control of the sensing apparatus from which the time-series signal is obtained. In applications where the sensing apparatus is degraded whilst taking measurements from certain substances (e.g. in biomedical applications involving sensing of an unknown fluid) the accurate identification of a transition start point can help reduce the time the sensing apparatus is exposed to such substances thereby prolonging the usability of the device.

Further features and aspects of the disclosure are provided in the appended claims.

### BRIEF DESCRIPTION OF DRAWINGS

The present disclosure will now be described by way of example only with reference to the accompanying drawings in which:

FIG. 1 illustrates an example time-series signal comprising a transition event;

FIG. 2 shows a general method for identifying a deviation point within a time-series signal according to an aspect of the present disclosure;

FIG. 3 shows a method for identifying a deviation point within a time-series signal according to an aspect of the present disclosure;

FIGS. 4A and 4B show plots of a first and a second time-series signal;

FIG. 5 illustrates an envelope calculated from the second time-series signal shown in FIG. 4B;

FIG. 6 shows the second time-series signal shown in FIG. 4B and a first envelope;

FIG. 7 shows the first time-series signal shown in FIG. 4A and a deviation point;

FIG. 8 shows a method for refining the deviation point according to an embodiment of the present disclosure;

FIG. 9 illustrates a refined deviation point;

FIG. 10 shows the first time-series signal shown in FIG. 4A and a model fit to the first time-series signal;

FIGS. 11A and B show a device according to an aspect of the present disclosure;

FIG. 12 shows a time-series signal corresponding to measurements received from the device of FIGS. 11A and B;

FIG. 13 shows the use of a deviation point to reduce the time during which the device of FIGS. 11A and B is exposed to an unknown fluid; and

FIG. 14 shows an example computing system for identifying a deviation point within a time-series signal according to an aspect of the present disclosure.

### DETAILED DESCRIPTION

Many applications within the domain of signal processing and time-series analysis involve time-series signals which capture transition events. For example, the signals capture a change from one state to another state, as described in more detail with reference to

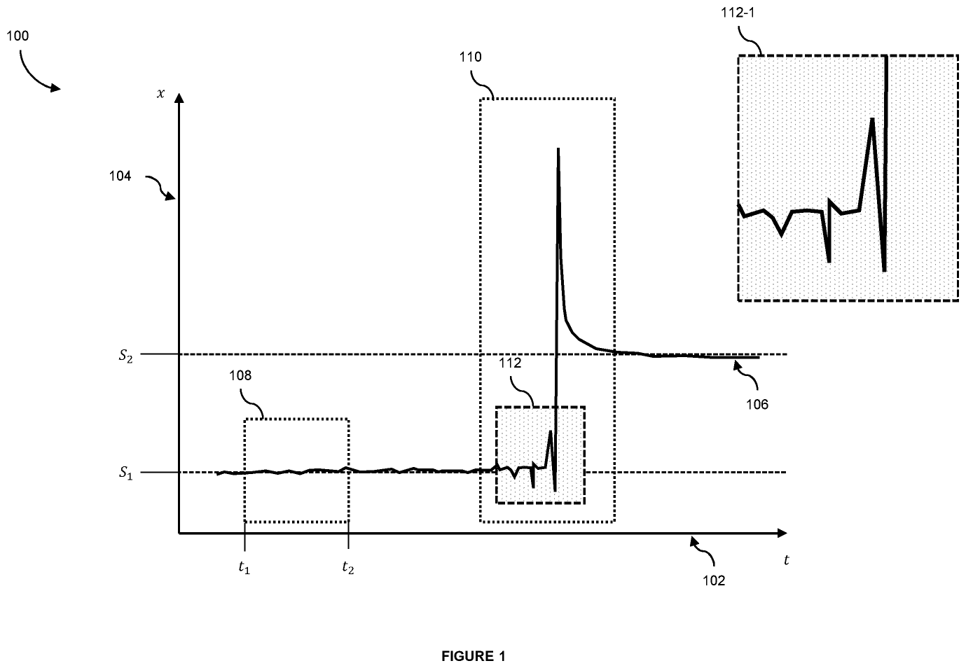

FIG. 1 below. These time-series signals are typically non-stationary, meaning that their statistical properties change over time. For example, measurements obtained from a microfluidic apparatus will change as the device transitions between measuring different fluids. The present disclosure is directed to deviation point, or change point, identification within such time-series signals.

FIG. 1 illustrates an example time-series signal comprising a transition event.

FIG. 1 shows a time-series plot 100 comprising a first axis 102 and a second axis 104. A time-series signal 106 is shown plotted against the first axis 102 and the second axis 104. The time-series signal 106 comprises a first portion 108 and a second portion 110. A sub-region 112 of the second portion 110 is shown along with an enlarged view 112-1 of the sub-region 112.

The time-series signal 106 comprises a sequence of observations indexed in time order, i.e. the sequence of observations occur successively over time. As such, the first axis 102 in the time-series plot 100 corresponds to a time value, t, and the second axis 104 in the time-series plot 100 corresponds to an observation value, x. The time-series signal 106 shown in the time-series plot 100 is generally non-stationary; that is, the statistical properties of the time-series signal 106 vary over time. However, portions of the time-series signal 106 may be stationary even though the time-series signal 106 considered as a whole is non-stationary.

The first portion 108 of the time-series signal 106 corresponds to a stationary portion, or substantially stationary portion, of the time-series signal 106. That is, the first portion 108 can be considered a finite variance process whose statistical properties are largely constant between time step t₁ and time step t₂.

The second portion 110 of the time-series signal 102 corresponds to a non-stationary portion of the time-series signal 106. Specifically, the second portion 110 corresponds to a transition event. A transition event may be understood as the portion of a time-series signal which captures a change of state of the underlying process recorded by the time-series signal. In the example shown in FIG. 1, the second portion 110 captures the change of the underlying process from a first state, represented as S₁ in the time-series plot 100, to a second state, represented as S₂ in the time-series plot 100. As the second portion 110 of the time-series signal 102 corresponds to a transition event, the first portion 108 of the time-series signal corresponds to a portion of the time-series signal 110 which does not correspond to a transition event. Thus, a substantially stationary portion of a time-series signal corresponds to a portion of the time-series signal which does not contain a transition event.

A transition event has a deviation point, also referred to as a transition point, a transition start point, a change point, or a start point, which corresponds to the time at which the underlying process starts to transition between states. In an ideal setting, the time-series signal would be largely noise free such that the transition event would be recognisable in the time-series signal as a clearly defined step function. The deviation point would thus be readily identifiable as the time at which the observation value changes. However, in nearly all systems, the time-series signal will comprise a certain degree of noise occurring due to factors such as noise within the underlying process, noise introduced during measurement of the underlying process, and/or noise occurring during transmission or digitisation of the time-series signal. The presence of such noise makes identifying the deviation point much more difficult. As shown in the enlarged view 112-1 of the time-series plot 100, it is not readily apparent at what time point the transition begins and so it is not readily apparent when the deviation point occurs.

The present disclosure is directed to a method and device for accurately and efficiently identifying a deviation point within a non-stationary time-series signal, such as the time-series signal 106 shown in FIG. 1.

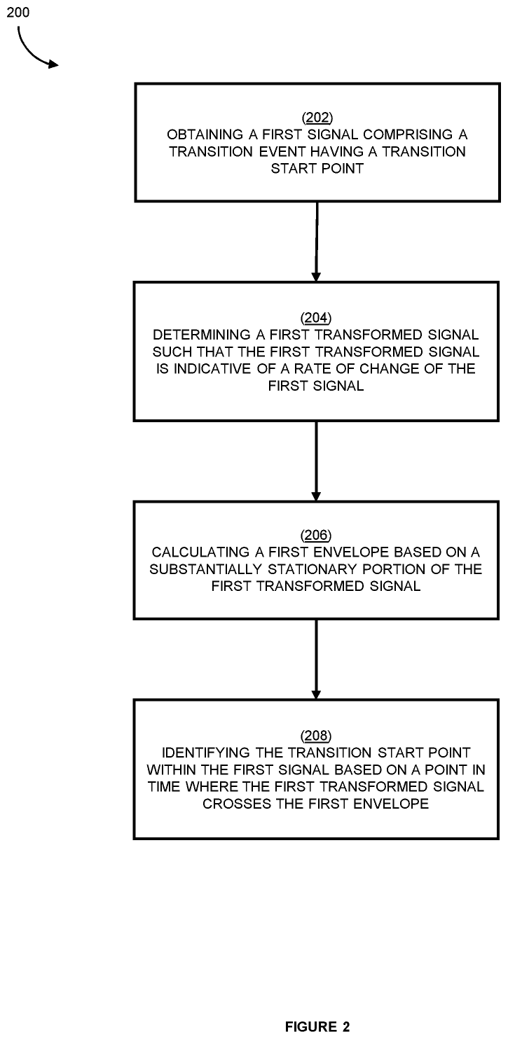

FIG. 2 shows a general method 200 for identifying a deviation point within a time-series signal according to an aspect of the present disclosure.

Method 200 comprises the step of obtaining 202 a first signal, such as the time-series signal 106 shown in FIG. 1, comprising a transition event, as shown in the second portion 110 in FIG. 1, having a transition start point. The method 200 further comprises the steps of determining 204 a first transformed signal such that the first transformed signal is indicative of a rate of change of the first signal, calculating 206 a first envelope based on a substantially stationary portion of the first transformed signal, and identifying 208 the transition start point within the first signal based on a point in time where the first transformed signal crosses the first envelope.

As will be described in more detail below, one non-limiting aspect of the present disclosure applies the above-described process to adjust the measurement process of a device comprising an ion selective electrode (ISE). The device is configured to measure an unknown fluid corresponding to a biological sample such as blood. As the device transitions from measuring a calibration fluid to measuring the unknown fluid, the above-described process is applied to identify the deviation point at the start of the transition. Once identified, the deviation point is used to reduce the exposure time of the ISE to the unknown fluid thereby improving the lifetime of the ISE. This reduction in exposure time is particularly important for devices configured to measure biological samples such as blood because excessive contact to such samples can lead to so called “bio fouling” whereby microorganisms accumulate on the wet surface of the ISE causing functional deficiencies. This inhibits the lifetime of the ISE and thus reduces the usability of the device.

The present disclosure therefore addresses the need for improved techniques for identifying the start point of a transition event within a time-series signal. Whilst some prior art techniques focus on extracting similar features from stationary time-series signal, the present disclosure can be applied to non-stationary time-series signals thereby allowing the technique to be applied in a range of different application areas.

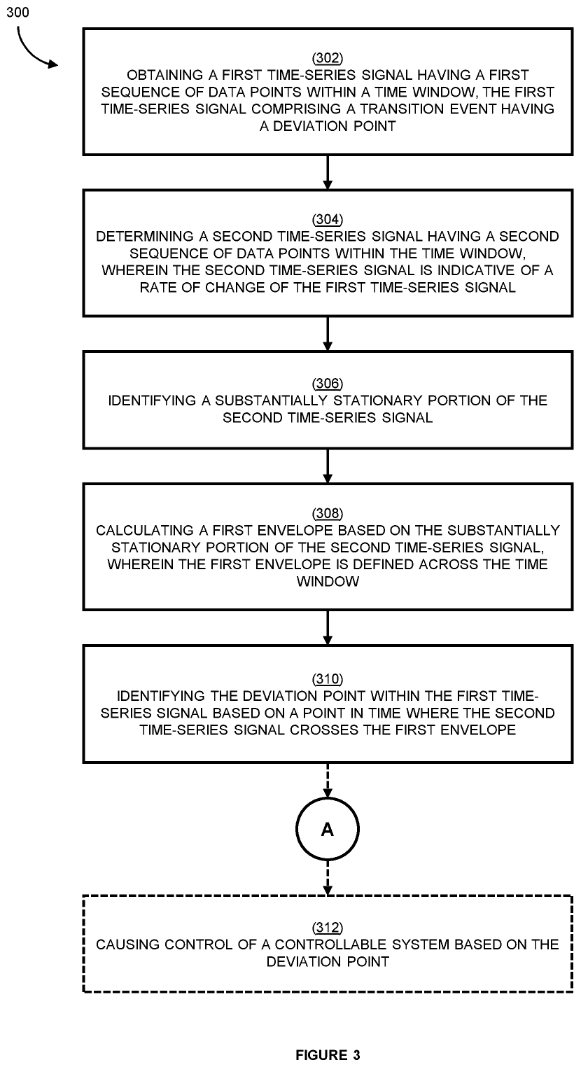

FIG. 3 shows a method 300 for identifying a deviation point within a time-series signal according to an aspect of the present disclosure.

The method 300 comprises the step of obtaining 302 a first time-series signal having a first sequence of data points within a time window, where the first time-series signal comprises a transition event having a deviation point.

The step of obtaining 302 the first time-series signal involves obtaining the first time-series signal from a persistent storage device or directly from a measurement device or from some other device. For example, the first time-series signal can be read directly from the output of a measurement device (e.g. via an analogue to digital converter or the like). Alternatively, the first time-series signal can be read from a file stored on a computer readable medium or within a memory. The first time-series signal may correspond to a portion of a larger time-series data stream. That is, the time window of the first time-series signal is a portion or window of a larger, potentially continuous, time-series data stream. Therefore, obtaining the first time-series signal in some implementations includes identifying and extracting a portion of a time-series data stream or another, longer, time-series signal.

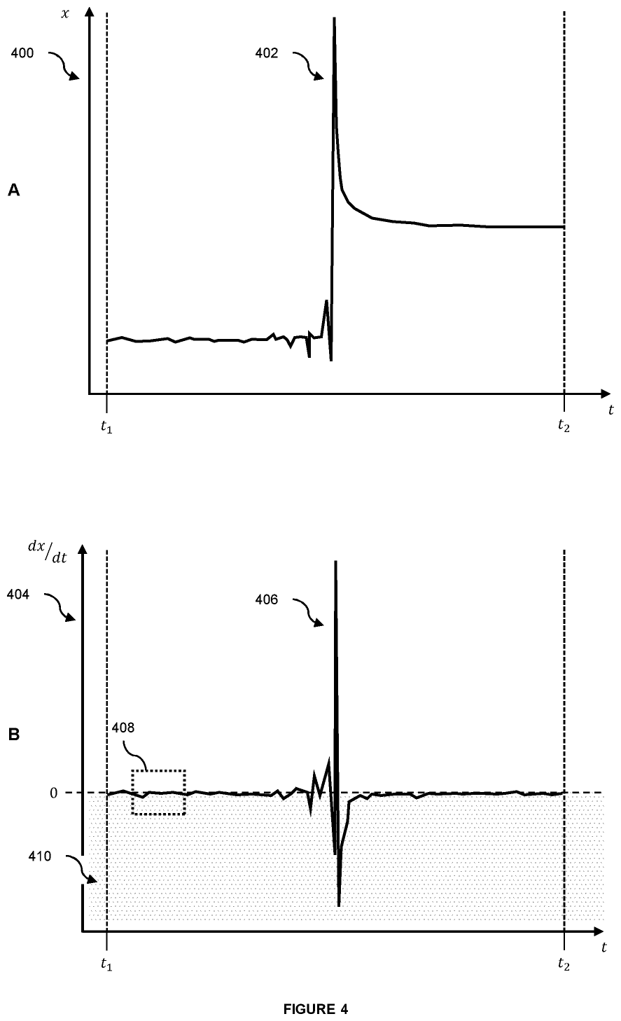

The first time-series signal comprises a sequence of observations indexed in time order, i.e. the sequence of observations occur successively over time. This is illustrated in FIG. 4A.

FIG. 4A shows a plot 400 of a first time-series signal 402.

As shown in the plot 400, the first time-series signal 402 spans a time window between time point t₁ and time point t₂. The first time-series signal 402 is a discrete signal comprising a sequence of data points (i.e. observations) ordered according to time. Typically, a time-series signal, such as the first time-series signal 402, corresponds to a sequence of temporal measurements of an underlying system or process. For example, the time-series signal may be a sequence of voltages read from an ion-selective electrode (ISE) as the ISE transitions from measuring a first biological sample to a second biological sample. In the example shown in the plot 400, the first biological sample is passing over the ISE at time point t₁ and the second biological sample is passing over the ISE at time point t₂. As such, up until the transition event, the ISE is in a first state and subsequent to the transition event the ISE is in a second state.

The first time-series signal 402 may correspond to a portion obtained from a larger time-series signal or data stream. Following on from the previous example, the first time-series signal-corresponding to a time window within which the ISE transitions from measuring a first biological sample to a second biological sample—may be obtained from a parent time-series signal which comprises a sequence of measurements over a longer time period (and thus potentially includes multiple transition events).

Within the context of the parent time-series signal, a transition event may be considered an outlier. As such, the first time-series signal, which is known to comprise a transition event, may be extracted from the parent time-series signal using an outlier detection approach. Outlier detection approaches include statistical profiling approaches, clustering based unsupervised approaches, and predictive confidence level approaches. For example, the interquartile range (IQR) rule can be employed as a statistical profiling approach to detect the general location of the transition event. Once the general location of the transition event within the parent time-series signal has been identified, a window around the transition event can be extracted to form the first time-series signal.

Whilst the first time-series signal 402 comprises a transition event which is known to have a transition start point, the exact time at which the transition start point occurs is unknown. As such, when the first time-series signal 402 is obtained, it can be referred to as comprising a transition event having an unknown transition start point (i.e. the time point associated with the start of the transition event is unknown). It is an object of the present disclosure to determine accurately the start point of the transition event.

Referring once again to FIG. 3, the method 300 further comprises the step of determining 304 a second time-series signal having a second sequence of data points within the time window, where the second time-series signal is indicative of a rate of change of the first time-series signal.

The second time-series signal is determined from the first time-series signal. Consequently, the first time-series signal and the second time-series signal are temporally aligned such that both signals span the same time window. As will be described in more detail below, the second time-series signal is utilised to identify the point in time in which the transition event starts (i.e. the deviation point) within the first time-series signal.

The second time-series signal is a transformation of the first time-series signal that captures the rate of change, or acceleration, of the first time-series signal. This is illustrated in FIG. 4B.

FIG. 4B shows a second time-series signal obtained from the first time-series signal 402 shown in FIG. 4A.

FIG. 4B shows a plot 404 of a second time-series signal 406, and a portion 408 of the second time-series signal 406. A negative region 410 of the plot 404 is also shown.

The second time-series signal 406 is obtained from the first time-series signal 402, described in relation to FIG. 4A, and spans the same time window—i.e. the second time-series signal 406 extends between time point t₁ and time point t₂. The second time-series signal 406 is indicative of a rate of change, or acceleration, of the first time-series signal 402. As such, the second time-series signal 406 corresponds to a derivative of the first time-series signal 402. In the example shown in the plot 404, the second time-series signal 406 corresponds to the first derivative of the first time-series signal 402.

However, higher-order derivatives, such as the second order derivative, third order derivative, and the like, may also be used to obtain the second time-series signal from the first time-series signal.

The first derivative of the first time-series signal may be calculated using a finite difference method. As is known, the finite difference method is used to approximate the derivative of a function from a set of data points when the exact formula for the function is not known. The finite difference method can also be used to calculate higher order derivatives such as the second derivative, third derivative, and the like. Alternatively, the first derivative may be calculated using symbolic differentiation, automatic differentiation, and the like.

Referring once again to FIG. 3, the method 300 further comprises the step of identifying 306 a substantially stationary portion of the second time-series signal.

Although the second time-series signal is generally non-stationary, portions of the second time-series signal will be substantially stationary; that is, the statistical properties of the portion of the second time-series signal will be relatively constant over time. Decisively, the substantially stationary portion of the second time-series signal corresponds to any portion of the second time-series signal which does not contain a transition event. As such, the substantially stationary portion of the second time-series signal may be alternatively referred to as a non-transition portion of the second time-series signal.

As shown in FIG. 4B, the portion 408 of the second time-series signal 406 is substantially stationary because the statistical properties of the portion 408 are largely constant over time.

The substantially stationary portion of the second time-series signal has a length such that the substantially stationary portion contains a set number of data points. Selecting the set number of data points to include within the substantially stationary portion therefore determines the predetermined length. Preferably, the set number of data points is greater than or equal to 10, and more preferably is greater than or equal to 20. More preferably still, the set number of data points is greater than 30 but less than 100 and more preferably still is equal to 50. The substantially stationary portion can then be identified using a sliding window approach whereby a window of the predetermined length (as described above) is placed over an initial portion of the second time-series signal. If the data points within the window satisfy a stationarity criterion, then the portion is identified as the substantially stationary portion. An example stationarity criterion is based on the mean and variance of sections of data within the window. The data points within the window may be split into sets (e.g. 2 sets, 4 sets, or 8 sets, etc.) and the mean and variance of the data points within each section may be calculated. The stationarity criterion may be met if the mean and variance across all sets is substantially the same, i.e. any change in the mean and variance is less than a predetermined, small, threshold value. If the stationarity criterion is not met, then the window is moved to a new position along the second time-series signal. For example, the starting point of the window is incremented by a predetermined amount. The above process is then repeated until the stationarity criteria is met.

Alternatively, the substantially stationary portion can be adaptively determined by identifying a starting point within the second time-series signal (e.g. the first data point within the second time-series signal) and iteratively increasing the number of data points to include within the substantially stationary portion that are proximate the starting point. For example, the first iteration includes the first five data points, the second iteration includes the first six data points, the third iteration includes the first seven data points, and so on. A statistical measure is taken over all points within the substantially stationary portion at each iteration. Example statistical measures include the mean value of all data points, the standard deviation, and the like. The iteration is terminated, and thus the identification of the substantially stationary portion is complete, once the statistical measure meets a termination criteria. For example, the termination criteria may be met when the difference between the statistical measure recorded across consecutive iterations is approximately zero.

As such, the stationary property of the portion 408 allows the portion 408 to be utilised as a baseline reference (since it is known that the portion 408 does not contain a transition event). As will be described in more detail below, this property allows for the transition point, or deviation point, of the transition event to be accurately determined.

Optionally, after performing the step of identifying 306, or after performing the step of calculating 308 (as described below), the method 300 further comprises the step of determining a global polarity of the second time-series signal.

Here, the global polarity of the second time-series signal refers to the primary direction, either positive or negative, of the second time-series signal. Effectively, the global polarity of the second time-series signal captures whether the transition event is a positive step or a negative step.

The global polarity may correspond to a polarity of a summary statistic calculated from the second time-series signal. For example, the observation values of the second time-series signal can be summed and the polarity (i.e. sign) of the median value be used to determine the global polarity of the second time-series signal. Alternatively, the global polarity is determined from a log-log transformation of the second time-series signal such that the direction of the slope, either positive or negative, of the log-log transformation corresponds to the global polarity of the second time-series signal.

Optionally, after the step of determining the global polarity of the second time-series signal, the method 300 further comprises a step of zeroing all data points in the second time-series signal having a polarity opposite to the global polarity.

In the example shown in FIG. 4B, as the global polarity of the second time-series signal 406 is positive, all negative values within the second time-series signal 406 will be set to the value zero. That is, all values of the second time-series signal 406 that are less than 0, i.e. those values within the negative region 410, will be zeroed. Performing such a pre-processing step can beneficially increase the accuracy of the identification of the deviation point by removing observations from the second time-series signal which do not necessarily contribute to the calculation of the first envelope.

Referring once again to FIG. 3, the method 300 further comprises the step of calculating 308 a first envelope based on the substantially stationary portion of the second time-series signal, wherein the first envelope is defined across the time window.

Generally, an envelope of a time-series signal corresponds to the boundary within which the time-series signal is substantially contained. The envelope of a time-series signal therefore includes an upper envelope, or upper portion, and a lower envelope, or lower portion. The upper envelope corresponds to a sequence of data points, or a curve, outlining the upper extreme of the signal, whilst the lower envelope corresponds to a sequence of data points, or a curve, outlining the lower extreme of the signal.

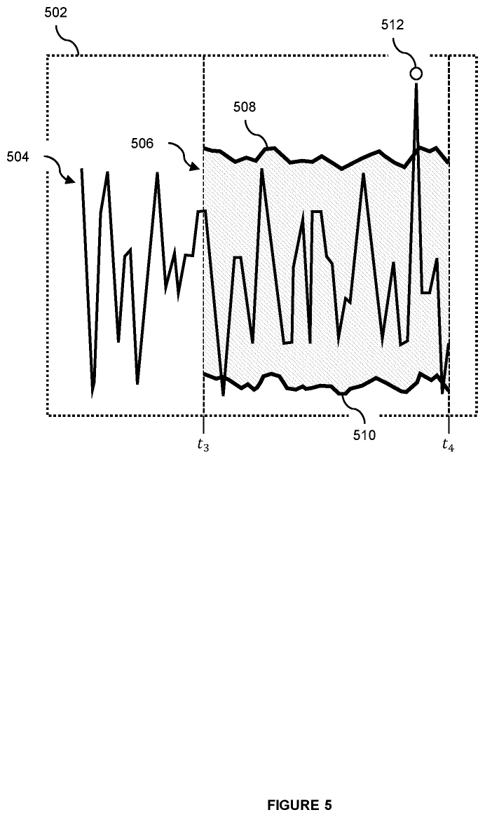

FIG. 5 illustrates an envelope calculated from the second time-series signal 406 shown in FIG. 4B.

FIG. 5 shows a magnified view 502 of a portion of a second time-series signal 504. The portion of the second time-series signal 504 shown in FIG. 5 corresponds to the portion 408 of the second time-series signal 406 shown in FIG. 4B. A first envelope 506 is shown for a sub-portion of the second time-series signal 504 between time points t₃ and t₄. The first envelope 506 comprises an upper portion 508, or upper envelope, and a lower portion 510, or lower envelope. Also shown is an outlier value 512.

Although an envelope may be calculated based on the upper and lower values of a time-series signal—e.g. all values above an average value of a signal correspond to the upper envelope and all values below the average value correspond to the lower envelope—it may be preferable to utilise the standard deviation of the time-series signal to determine the envelope.

As such, in an embodiment, the first envelope is based on a standard deviation calculated from datapoints within the substantially stationary portion of the second time-series signal. In the example shown in FIG. 5, the first envelope 506 is calculated based on the standard deviation of all datapoints (all values) of the second time-series signal 504 between the time points t₃ and t₄. It is to be noted that the use of the time points t₃ and t₄ is primarily for illustrative purposes and the calculations could also be made for all datapoints within the substantially stationary portion or any sub-portion thereof. The upper envelope is then determined for a given time point by adding the standard deviation to the value of the second time-series signal 504 at that time point. Similarly, the lower envelope is determined for a given time point by subtracting the standard deviation from the value of the second time-series signal 504 at that time point.

Alternatively, a moving average can be used in place of the second time-series signal value. For example, for a given time point, the average value of the second time-series signal within a window around the given time point can be calculated and the upper and lower envelopes determined from that average value. The size of the window is chosen to contain a predetermined number of values, e.g. 5 values, 10 values, etc. This approach is shown in FIG. 5 whereby the upper portion 508 and the lower portion 510 are calculated using a moving average and the standard deviation of the second time-series signal 504 between the time points t₃ and t₄. Beneficially, this approach is more robust to noise and outliers such as the outlier value 512.

Similarly, a moving standard deviation can be used instead of the standard deviation of all values of the second time-series signal 504 between the time points t₃ and t₄, or all values within the portion of the second time-series signal 504 shown in FIG. 5. For example, for a given time point, the standard deviation of the second time-series signal within a window around the given time point can be calculated and the upper and lower envelopes determined using that standard deviation value. The two approaches may be combined such that a moving average and a moving standard deviation are used.

Following on from the above approaches, in one embodiment the first envelope corresponds to a Bollinger Band. Bollinger Bands are typically used to display the volatility of an underlying signal and comprise an envelope plotted at a predetermined standard deviation level above and below a moving average. More particularly, the upper portion of a Bollinger Band, or an upper band, is computed as MAₖ+mσₖ and the lower portion of a Bollinger Band, or a lower band, is computed as MAₖ+mσₖ. Here, MAₖ corresponds to the moving average of the time-series signal over a period k; σₖ corresponds to the standard deviation of the time-series signal over the period k; and m corresponds to a scaling factor. The value of the period, k, determines the size of the moving average and moving standard deviation. Typically, k∈[3,20] although the value of k can be increased (e.g. k=30, k=50) if the substantially stationary portion of the second time-series has a high level of noise. Preferably, the value for the scaling factor is set at m>0, more preferably the scaling factor is set at 1<m<3, more preferably again the scaling factor is set at 1.5<m<2.5, and more preferably still the scaling factor is set at m=2.

Although the first envelope is determined using only a portion of the second time-series signal—e.g. the values of the second time-series signal 504 within the portion or between time points t₃ and t₄—the first envelope is defined across the entire time window of the second time-series signal 504. That is, the first envelope is extended across the entire time window shown in FIGS. 4A and 4B from time point t₁ to time point t₂. The first envelope is extended across the time window by taking the maximum value of the upper envelope and extending that value between time point t₁ to time point t₂, and taking the minimum value of the lower envelope and extending that value between time point t₁ to time point t₂. The envelope is thus defined by scalar threshold values corresponding to the maximum and minimum of the upper and lower envelopes. Alternatively, the first envelope is extended across the entire time window from time point t₁ to time point t₂ by extending a given value of the upper and lower envelope (e.g. extending the average value, minimum value, starting value, ending value, etc.).

Once the first envelope has been determined, it is used to identify the deviation point within the first time-series signal.

Referring once again to FIG. 3, the method 300 further comprises the step of identifying 310 the deviation point within the first time-series signal based on a point in time where the second time-series signal crosses the first envelope.

The deviation point within the first time-series signal is identified based on an analysis of the second time-series signal. That is, the second time-series signal is used to identify a point in time associated with the deviation point. Because the first time-series signal and the second time-series signal are temporally aligned (i.e. they span the same time window), the point in time is therefore also associated with the deviation point within the first time-series signal.

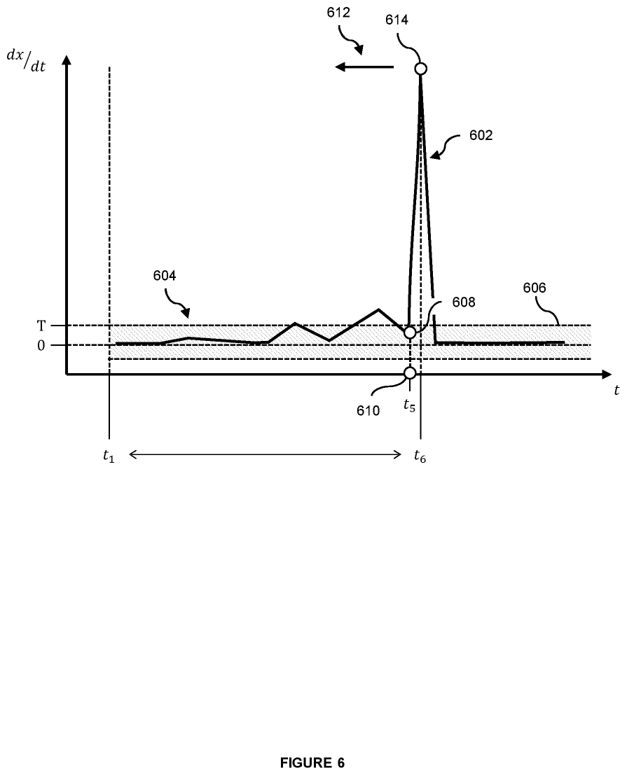

The point in time associated with the deviation point is determined by identifying a point at which the second time-series signal crosses the first envelope. This is illustrated in FIG. 6.

FIG. 6 shows a plot 600 of a second time-series signal 602 and a first envelope 604.

The first envelope 604 has an upper portion 606 which corresponds to a scalar threshold set at value T. The second time-series signal 602 has a deviation point 608 at the time point 610. FIG. 6 further shows a reverse temporal direction 612 and an absolute maximum value 614 of the second time-series signal 602.

The second time-series signal 602 corresponds to a processed form of the second time-series signal 406 shown in FIG. 4B. The second time-series signal 602 has been processed such that all datapoints having a polarity opposite to the global polarity have been zeroed. In the example shown in FIG. 6, this corresponds to negative values in the second time-series signal being zeroed.

The deviation point 608 within the second time-series signal 602 corresponds to the time point 610, t₅, where the second time-series signal 602 crosses the first envelope 604. More particularly, the deviation point 608 corresponds to the time point 610 where the second time-series signal 602 crosses the upper portion 606 of the first envelope 604, i.e. crosses the threshold T. The deviation point within the first time-series signal can then be identified as the data point within the first time-series signal having a time value equal to the time point 610, i.e. the value within the first time-series signal at time point t₅.

In one embodiment, the deviation point 608 within the second time-series signal 602 is identified by iterating along the second time-series signal 602 in a reverse temporal direction 612 to identify the time point 610 where the second time-series signal 602 crosses the first envelope 604.

To limit the scope of the search performed by the iterating step, the search can be performed within a search window. As such, in one embodiment the method 300 of FIG. 3 further comprises the step of determining a search window corresponding to a sub-portion of the time window. The search window is defined between a pair of boundary time points, such that the deviation point is identified within the search window. A first boundary time point, shown as t₆ in FIG. 6, of the pair of boundary time points corresponds to a time point associated with the maximum absolute value 614 of the second time-series signal 602. A second boundary time point, shown as t₁ in FIG. 6, of the pair of boundary time points corresponds to a boundary time point of the time window. As such, the search window in one embodiment is defined between the boundary time points t₁ and t₆.

Starting from the first boundary point, corresponding to the maximum absolute value 614, the second time-series signal 602 can be traversed in the reverse temporal direction 612 until the time point 610 is reached whereby the second time-series signal 602 first crosses the first envelope 604, i.e. crosses the upper portion 606. Here, the second time-series signal 602 is considered to cross the first envelope 604 because the deviation point 608 lies within the first envelope 604. Put another way, the value of the deviation point 608 is the first value of the second time-series signal 602 which is below the threshold T, i.e. below the upper portion 606, when traversing the second time-series signal 602 from the boundary point (the maximum absolute value 614) in the reverse temporal direction 612. Alternatively, the value of the deviation point 608 is the first value of the second time-series signal 602 which is below or equal to the threshold T, i.e. below the upper portion 606, when traversing the second time-series signal 602 from the boundary point (the maximum absolute value 614) in the reverse temporal direction 612

Given that the second time-series signal 602 may cross the first envelope 604 multiple times, the deviation point 608 within the second time-series signal 602 is identified based on the time point 610 where the second time-series signal 602 crosses the first envelope 604 proximate the first boundary point, i.e. proximate the maximum absolute value 614 of the second time-series signal 602. Put another way, the deviation point 608 corresponds to a crossing of the second time-series signal 602 and the first envelope 604 which is temporally closest to the maximum absolute value 614.

As an alternative to the above iterative approach, the deviation point is identified using a piecewise operation. If the second time-series signal 602 is represented by a one-dimensional vector, then a piecewise operation can be applied to the vector to identify only those values which fall within the first envelope 604 (i.e. values below the upper portion 606). For example, all values of the one-dimensional vector which do not fall within the first envelope 604 can be zeroed. The deviation point 608 within the second time-series signal 602 is then identified as the closest non-zero value to the first boundary time point, t₆, in the reverse temporal direction 612.

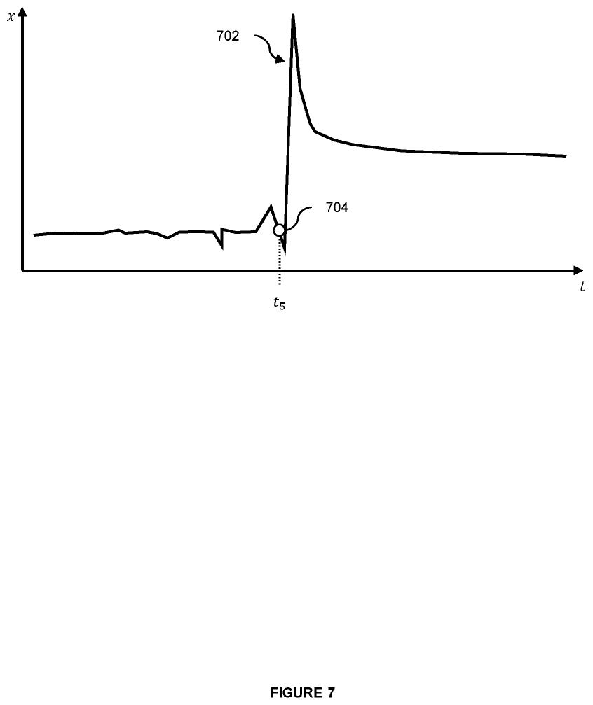

Whilst the above description relates to identifying the deviation point 608 within the second time-series signal 602, the deviation point within the first time-series signal is identified as the data point within the first time-series signal having a time value equal to the time point 610, i.e. the value within the first time-series signal at time point t₅. This is illustrated in FIG. 7.

FIG. 7 shows a first time-series signal 702 and a deviation point 704. The first time-series signal 702 corresponds to the first time-series signal 402 described in relation to FIG. 4A. The deviation point 704 corresponds to the data point within the first time-series signal 702 at time point t₅, i.e. the data point within the first time-series signal 702 at the time point 610 identified from the second time-series signal 602 as described in relation to FIG. 6.

The above discussion has focussed on the case where the transition event is positive. The above principles are equally applicable to the case where the transition event is negative. The skilled person will appreciate that in such circumstances the deviation point is identified in much the same way as that described above. The primary difference for a negative transition event is that the global polarity of the second time-series signal will be negative. Consequently, the deviation point will be identified based on the second time-series signal crossing the lower portion of the envelope.

In an embodiment, the deviation point can be further refined by repeating the above analysis using the first time-series signal rather than the second time-series signal. This refinement helps ensure that the deviation point is accurately determined.

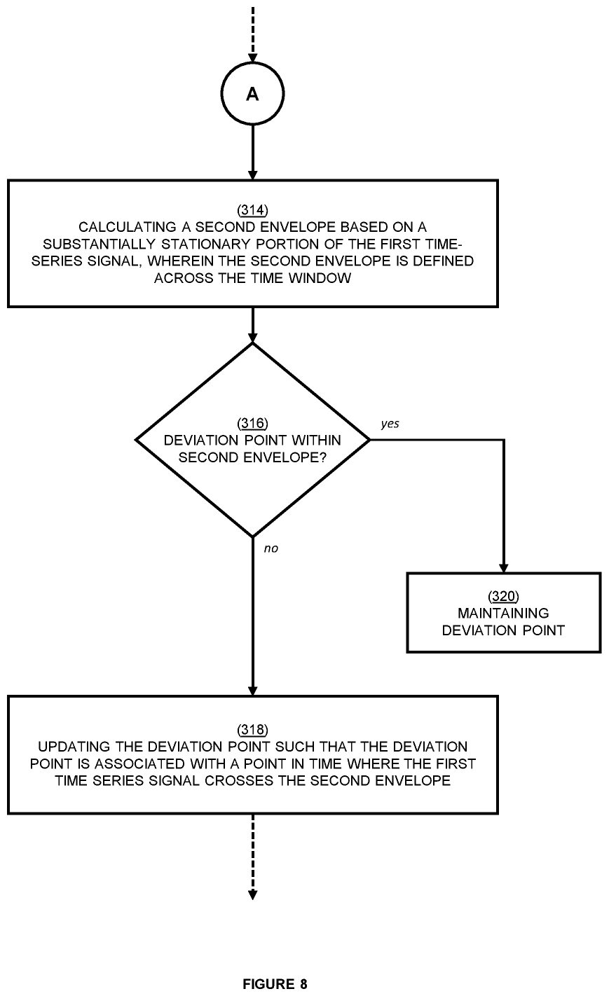

FIG. 8 shows a method for refining the deviation point according to an embodiment.

The method shown in FIG. 8 is used in conjunction with the steps of the method 300 described in relation to FIG. 3. Specifically, the steps shown in FIG. 8 can be performed after the step of identifying 310 in the method 300.

The method shown in FIG. 8 comprises the step of calculating 314 a second envelope based on a substantially stationary portion of the first time-series signal, wherein the second envelope is defined across the time window.

The second envelope for the first time-series signal is calculated in the same manner as the first envelope for the second time-series signal. Therefore, the above description relating to the calculation of the first envelope (with reference to FIGS. 3-7) is applicable to the calculation of the second envelope for the first time-series signal.

The method shown in FIG. 8 further comprises the step of, in accordance with a determination 316 that the deviation point is not within a region defined by the second envelope, updating 318 the deviation point such that the deviation point is associated with a point in time where the first time-series signal crosses the second envelope. Alternatively, in accordance with a determination 316 that the deviation point is within a region defined by the second envelope, the method comprises the step of maintaining 320 the deviation point.

If the deviation point lies within both the first envelope and the second envelope, then there is no further refinement of the deviation point to be made. If the deviation point lies within the first envelope but not within the second envelope, then the deviation point is refined by updating the deviation point to a point where the first time-series signal crosses the second envelope.

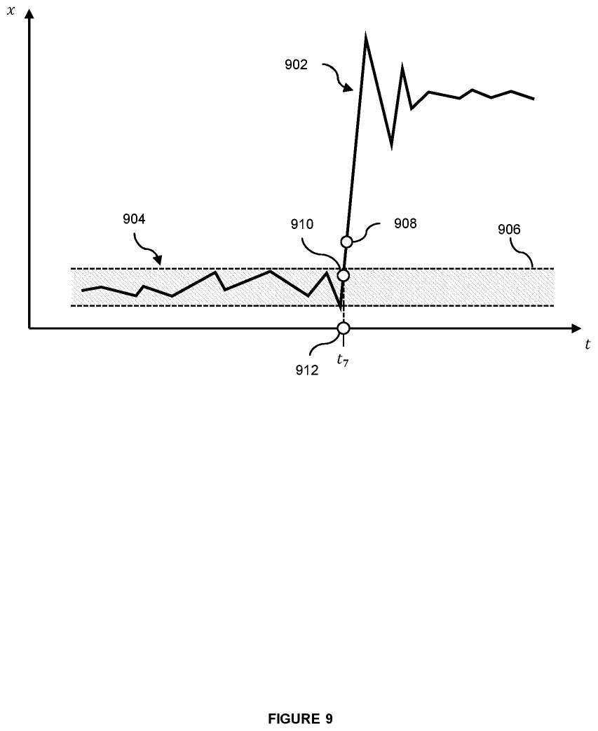

The process described in FIG. 8 is illustrated by the example shown in FIG. 9.

FIG. 9 shows a first time-series signal 902 and a second envelope 904 calculated from a substantially stationary portion of the first time-series signal 902. The second envelope 904 comprises an upper portion 906. FIG. 9 further shows a first deviation point 908 and a second deviation point 910 at a point in time 912.

The first deviation point 908 corresponds to the deviation point determined from a second time-series signal using the process as described in relation to FIGS. 3-6. In this example, the first deviation point 908 does not accurately correspond to the start point of the transition event. This could be due to the non-stationarity of the second times-series signal where the morphology of the signal is highly complex. An updated deviation point, corresponding to the second deviation point 910, is determined by identifying the point in time 912, t₇, at which the first time-series signal 902 crosses the second envelope 904, i.e. the first time-series signal 902 crosses the upper portion 906. The updated deviation point (the second deviation point 910) and the point in time 912 can be obtained in the same way as the deviation point 608 and the time point 610 are obtained as described in relation to FIG. 6. However, rather than setting the first boundary point to be the maximum absolute value of the first time-series signal 902, the first boundary point can instead be set to the first deviation point 908 thereby further reducing the search space within which the updated deviation point is to be sought. Consequently, the updated deviation point is identified based on the point in time 912 where the first time-series signal 902 crosses the second envelope 904 proximate the first deviation point 908, i.e. the crossing which is temporally closest to the first deviation point 908.

Identifying the deviation point within a time-series signal using the approaches described above in relation to FIGS. 3-9 may allow a precise determination of the start of a transition event to be made. Moreover, the above approach can be implemented and executed in near real time on low computation, or edge, devices because of the approach's inherent efficiency. As will be described in more detail below, this accuracy and efficiency may enable improved control of controllable systems and devices.

As such, and referring once again to FIG. 3, in one embodiment the method 300 further comprises the optional step of causing 312 control of a controllable system based on the deviation point.

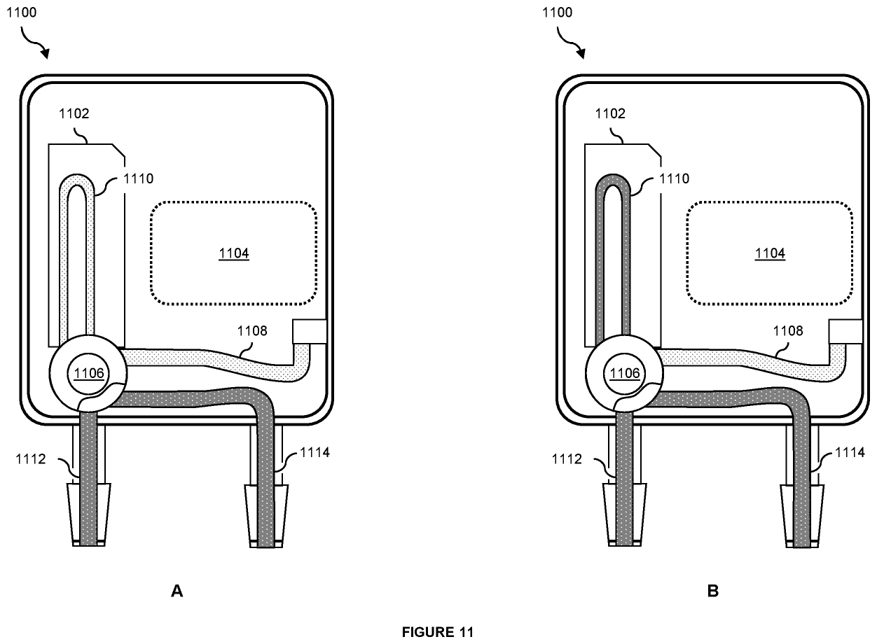

In the present disclosure, a controllable system corresponds to any device or system which can be adapted, managed, or controlled. Example controllable systems include but are not limited to measurement devices, control systems, sensor systems, industrial control systems, and the like. Causing control of a controllable system typically comprises causing a command to be issued to the controllable system to adapt or change functionality of the controllable system. The command, which causes the controllable system to change functionality or operation, is based on the identified deviation point. These aspects are described in more detail with reference to FIGS. 11 to 13 below.

The control of the controllable system can be further based on a model which is fit to the first time-series data based on the deviation point.

The method 300 thus optionally comprises the step of fitting a model to the first time-series signal based on the deviation point, where control of the controllable system is based on the model fitted to the first time-series signal.

Any suitable model can be used to fit to the first time-series signal given the deviation point. In one example, the model corresponds to an exponential function. In alternative examples, the model corresponds to a regression model, machine learning model, or the like.

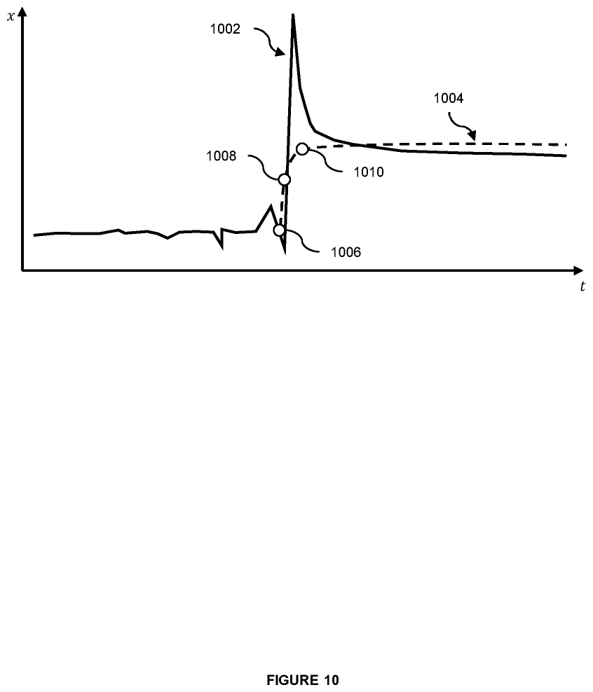

FIG. 10 shows a time-series signal and a model fit to the time-series signal.

FIG. 10 shows a first time-series signal 1002, which corresponds to the first time-series signal 402 described in relation to FIG. 4A, and a model 1004 fit to the first time-series signal 1002. FIG. 10 further shows a deviation point 1006, which corresponds to the deviation point 704 described in relation to FIG. 7, along with a first intermediary point 1008 and a second intermediary point 1010.

The model 1004, illustrated by the dashed line in FIG. 10, is fit to the first time-series signal 1002 based on the deviation point 1006. In this example, the model 1004 corresponds to an exponential function. Consequently, the deviation point 1006 represents the time constant, τ, of 0, or the point at which the exponential function reaches 0% of its final value. The first intermediary point 1008 represents the point at which the exponential function is at approximately 60% of its final value, and the second intermediary point 1010 represents the point at which the exponential function is at approximately 90% of its final value.

Decisively, the second intermediary point 1010 represents the point at which the underlying process has largely transitioned to the second state. As such, accurately identifying the deviation point 1006 may enable an accurate model to be fit such that more accurate control of the controllable system can be provided. This is described in more detail in relation to FIGS. 11 to 13 below.

FIG. 11A and B show an example controllable system according to an aspect of the present disclosure.

FIGS. 11A and B show a device 1100 (i.e. controllable system) comprising a sensor 1102, a reservoir 1104, and a valve 1106. A first fluid channel 1108 connects the reservoir 1104 and the valve 1106. A second fluid channel 1110 passes through and over the sensor 1102 from the valve 1106. A fluid inlet 1112 and a fluid outlet 1114 are both connected to the valve 1106.

The sensor 1102 is a polymer-based ion selective electrode (ISE). As is known, an ISE provides spot monitoring by converting the activity of an ion dissolved in a solution to electrical potential. ISEs are widely used within the fields of medicine, biology, and analytical chemistry. Typical applications include using an ISE in biomedical devices to measure the concentration of calcium, potassium, and sodium in bodily fluids such as blood, and using an ISE for pollution monitoring by measuring the concentration of fluorine, copernicium, etc. in water.

In use, the sensor 1102 is typically “flushed” with a calibration fluid before being exposed to an unknown fluid from which measurements are to be take. The calibration fluid flows from the reservoir 1104 through the first fluid channel 1108 to the valve 1106. The calibration fluid flows back to the reservoir 1104 through a further fluid channel. Alternatively, the calibration fluid flows back to the reservoir 1104 through the first fluid channel 1108. The unknown fluid flows from an external source (not shown) through the fluid inlet 1112 to the valve 1106 and from the valve 1106 through the fluid outlet 1114 to be further disposed of (e.g. flows to waste).

The valve 1106 is controlled by an external controller (not shown) such as a computing device or other external device. Configuration settings of the valve 1106 are adjusted by means of the external controller. Specifically, commands are sent to the device 1100 to control actuation of the value 1106.

In a first mode of operation (FIG. 11A), the valve 1106 is configured to allow the calibration fluid to flow from the reservoir 1104 through the first fluid channel 1108 to the second fluid channel 1110. The sensor 1102 then takes reference measurements from the calibration fluid flowing through the second fluid channel 1110.

In a second mode of operation (FIG. 11B), the valve 1106 is configured to allow the unknown fluid to flow from the external source (not shown) through the fluid inlet 1112 to the second fluid channel 1110. The sensor 1102 then takes measurements from the unknown fluid flowing through the second fluid channel 1110. The unknown fluid passes from the second fluid channel 1110 to the fluid outlet 1114 and out of the device 1100.

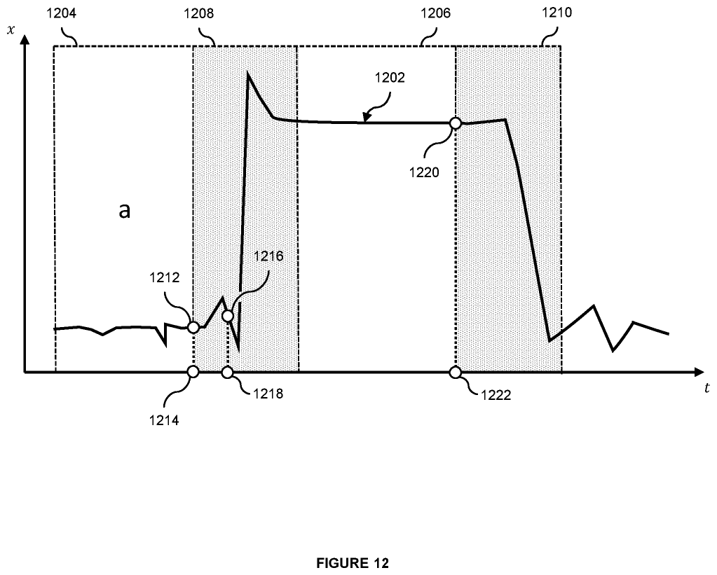

The sensor 1102 responds differently to the two fluids. The response of the sensor 1102 is measured as a voltage developed between the inside and the outside of the ion sensitive membrane of the sensor 1102. The time-series signal of the change in voltage received from the sensor 1102 over time will capture the transition of the sensor 1102 from measuring the calibration fluid to measuring the unknown fluid. This is illustrated in FIG. 12.

FIG. 12 shows a time-series signal corresponding to the measurements received from the device 1100 of FIGS. 11A and B as an unknown fluid is passed over the sensor 1102.

FIG. 12 shows a signal 1202, a first measurement period 1204, a second measurement period 1206, a first transition period 1208, and a second transition period 1210. The signal 1202 comprises a first point 1212 at a first time point 1214, a second point 1216 at a second time point 1218, and a third point 1220 at a third time point 1222.

With reference also to FIGS. 11A and B, the first measurement period 1204 is indicative of a period when the device 1100 is measuring a calibration fluid, i.e. the calibration fluid held in the reservoir 1104 is passing through the sensor 1102 (FIG. 11A). At the first time point 1214, a command is sent to the device 1100 to transition from measuring the calibration fluid to measuring the unknown fluid. In consequence of receiving the command, the valve 1106 is actuated such that the calibration fluid ceases to pass through the sensor 1102 and instead the unknown fluid entering the device 1100 from the fluid inlet 1112 passes through the sensor 1102 (FIG. 11B). During the second measurement period 1206 the device 1100 measures the unknown fluid and at the third time point 1222 a command is sent to the device to cease measuring the unknown fluid and transition back to measuring the calibration fluid (i.e. the valve 1106 is actuated such that the calibration fluid held in the reservoir 1104 is once again passing through the sensor 1102).

The first time point 1214 corresponds to the time at which the command is sent to the device 1100 to change from measuring the calibration fluid to measuring the unknown fluid. In such a microfluidic system, the change from measuring one fluid to another takes time. This is what is captured in the first transition period 1208 where the device enters the first transition period 1208 in a first state (i.e. measuring a calibration fluid) and exits the first transition period 1208 in a second state (i.e. measuring an unknown fluid). Due to variation in sensors, the length of the first transition period 1208 is often predetermined to a possible overestimate of the amount of time taken to transition between states. However, such an overestimate can lead to the unknown fluid being in contact with the sensor 1102 for a longer time than necessary. In applications involving the measurement of unknown biological fluids, such excessive contact can lead to so called “bio fouling” whereby microorganisms accumulate on the wet surface of the sensor 1102 causing functional deficiencies. This inhibits the lifetime of the sensor 1102 and thus reduces the usability of the device 1100.

Identifying the deviation point (i.e. the time point at which the device 1100 changes from measuring one fluid to another) may enable a reduction in the time for which the unknown fluid is passing through the sensor 1102.

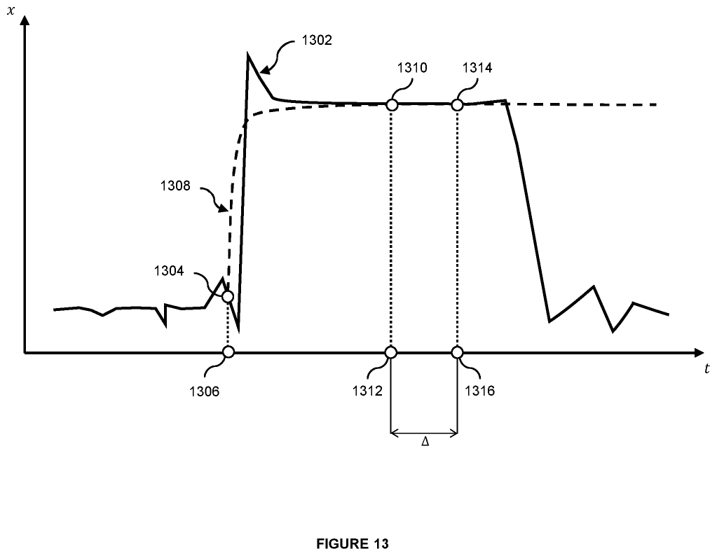

FIG. 13 shows an example use of the deviation point to reduce the time during which the sensor 1102 of the device 1100 is exposed to the unknown fluid.

FIG. 13 shows a signal 1302 and a deviation point 1304 at a first time point 1306. A model 1308 is fitted to the signal 1302 at the deviation point 1306. FIG. 13 further shows a first stop point 1310 at a second time point 1312 and a second stop point 1314 at a third time point 1316. The signal 1302, the deviation point 1304, the first time point 1306, the second stop point 1314, and the third time point 1316 correspond to the signal 1202, the second point 1216, the second time point 1218, the third point 1220, and the third time point 1222 shown in FIG. 12 respectively.

The deviation point 1304 corresponds to the point at which the device 1100 changes from measuring one fluid to another and is estimated using the methods of the present disclosure (as described above in relation to FIGS. 2 to 10). At the second time point 1312, the model 1308 is fit to the signal 1302. If the model is a good fit to the signal 1302, then a command can be issued at the second time point 1312 to instruct the device 1100 to transition from measuring the unknown fluid to measuring the calibration fluid. The fit of the model 1308 is measured using a goodness of fit (e.g. R² coefficient) with a predetermined threshold (e.g. 95%) such that if the goodness of fit of the model 1308 to the signal 1302 exceeds the predetermined threshold, then the model is considered a good fit. The period between the first time point 1306 and the second time point 1312 is preferably set to a predetermined length such as 3 seconds, 5 seconds, and the like, to allow for a good fit and avoid repeatedly fitting the model 1308.

By identifying the deviation point 1304 the command can be sent to stop measuring the unknown fluid sooner. As shown in FIG. 12, the command is sent at the second time point 1312 which is sooner than the command would otherwise have been sent (i.e. at the third time point 1316). Therefore, the time during which the device 1100 is measuring the unknown fluid is reduced by the difference between the third time point 1316 and the second time point 1312, A. This reduction may lead to a reduction in bio fouling, which should improve the performance of device 1100 by increasing the lifetime of the sensor 1102.

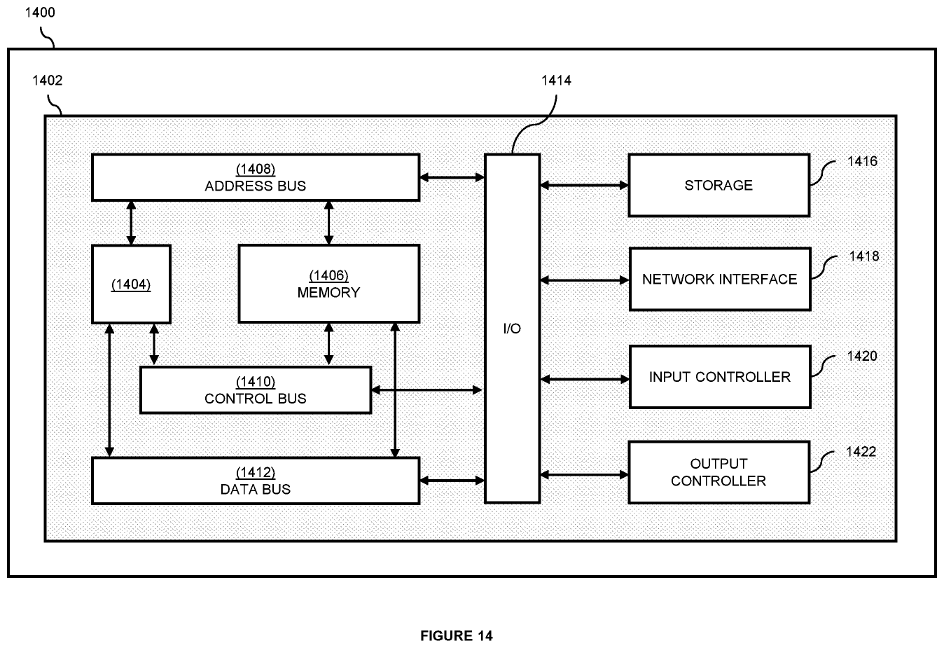

FIG. 14 shows an example computing system for identifying a deviation point within a time-series signal. Specifically, FIG. 14 shows a block diagram of an embodiment of a computing system according to example aspects and embodiments of the present disclosure.

Computing system 1400 can be configured to perform any of the operations disclosed herein such as, for example, any of the operations discussed with reference to the method described in relation to FIGS. 2 and 8. Computing system includes one or more computing device(s) 1402. One or more computing device(s) 1402 of computing system 1400 comprise one or more processors 1404 and memory 1406. One or more processors 1404 can be any general-purpose processor(s) configured to execute a set of instructions. For example, one or more processors 1404 can be one or more general-purpose processors, one or more field programmable gate array (FPGA), and/or one or more application specific integrated circuits (ASIC). In one embodiment, one or more processors 1404 include one processor. Alternatively, one or more processors 1404 include a plurality of processors that are operatively connected. One or more processors 1404 are communicatively coupled to memory 1406 via address bus 1408, control bus 1410, and data bus 1412. Memory 1406 can be a random-access memory (RAM), a read-only memory (ROM), a persistent storage device such as a hard drive, an erasable programmable read-only memory (EPROM), and/or the like. Computing device(s) 1402 further comprise I/O interface 1414 communicatively coupled to address bus 1408, control bus 1410, and data bus 1412.

Memory 1406 can store information that can be accessed by one or more processors 1404. For instance, memory 1406 (e.g. one or more non-transitory computer-readable storage mediums, memory devices) can include computer-readable instructions (not shown) that can be executed by one or more processors 1404. The computer-readable instructions can be software written in any suitable programming language or can be implemented in hardware. Additionally, or alternatively, the computer-readable instructions can be executed in logically and/or virtually separate threads on one or more processors 1404. For example, memory 1406 can store instructions (not shown) that when executed by one or more processors 1404 cause one or more processors 1404 to perform operations such as any of the operations and functions for which computing system 1400 is configured, as described herein. In addition, or alternatively, memory 1406 can store data (not shown) that can be obtained, received, accessed, written, manipulated, created, and/or stored. In some implementations, computing device(s) 1402 can obtain from and/or store data in one or more memory device(s) that are remote from the computing system 1400.

Computing system 1400 further comprises storage unit 1416, network interface 1418, input controller 1420, and output controller 1422. Storage unit 1416, network interface 1418, input controller 1420, and output controller 1422 are communicatively coupled via I/O interface 1415.

Storage unit 1416 is a computer readable medium, preferably a non-transitory computer readable medium, comprising one or more programs, the one or more programs comprising instructions which when executed by one or more processors 1404 cause computing system 1400 to perform the method steps of the present disclosure. Alternatively, storage unit 1416 is a transitory computer readable medium. Storage unit 1416 can be a persistent storage device such as a hard drive, a cloud storage device, or any other appropriate storage device.

Network interface 1418 can be a Wi-Fi module, a network interface card, a Bluetooth module, and/or any other suitable wired or wireless communication device. In an embodiment, network interface 1418 is configured to connect to a network such as a local area network (LAN), or a wide area network (WAN), the Internet, or an intranet.

FIG. 14 illustrates one example computing system 1400 that can be used to implement the present disclosure. Other computing systems can be used as well. Computing tasks discussed herein as being performed at and/or by one or more functional unit(s) can instead be performed remote from the respective system, or vice versa. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implemented tasks and/or operations can be performed sequentially or in parallel. Data and instructions can be stored in a single memory device or across multiple memory devices.

1. A computer-implemented method for identifying a deviation point within a time-series signal, the computer-implemented method comprising:
obtaining a first time-series signal having a first sequence of data points within a time window, the first time-series signal comprising a transition event having a deviation point;
determining a second time-series signal having a second sequence of data points within the time window, wherein the second time-series signal is indicative of a rate of change of the first time-series signal;
identifying a substantially stationary portion of the second time-series signal;
calculating a first envelope based on the substantially stationary portion of the second time-series signal, wherein the first envelope is defined across the time window; and
identifying the deviation point within the first time-series signal based on a point in time where the second time-series signal crosses the first envelope.

2. The computer-implemented method of claim 1 further comprising:
causing control of a controllable system based on the deviation point.

3. The computer-implemented method of claim 2 further comprising, after determining the deviation point:
fitting a model to the first time-series signal based on the deviation point;
wherein control of the controllable system is based on the model fitted to the first time-series signal.

4. The computer-implemented method of claim 1 further comprising, after identifying the deviation point:
calculating a second envelope based on a substantially stationary portion of the first time-series signal, wherein the second envelope is defined across the time window; and
in accordance with a determination that the deviation point is not within a region defined by the second envelope:
updating the deviation point such that the deviation point is associated with a point in time where the first time-series signal crosses the second envelope.

5. The computer-implemented method of claim 1 further comprising:
determining a search window corresponding to a sub-portion of the time window, the search window being defined between a pair of boundary time points;
wherein the deviation point is identified within the search window.

6. The computer-implemented method of claim 5 wherein a first boundary time point of the pair of boundary time points corresponds to a time point associated with a maximum absolute value of the second time-series signal.

7. The computer-implemented method of claim 6 wherein a second boundary time point of the pair of boundary time points corresponds to a boundary time point of the time window.

8. The computer-implemented method of claim 1 further comprising:
determining a global polarity of the second time-series signal.

9. The computer-implemented method of claim 8 further comprising:
zeroing all data points in the second time-series signal having a polarity opposite to the global polarity.

10. The computer-implemented method of claim 8 wherein the global polarity corresponds to a polarity of a summary statistic calculated from the second time-series signal.

11. The computer-implemented method of claim 8 wherein the global polarity is determined from a log-log transformation of the second time-series signal.

12. The computer-implemented method of claim 1 wherein the deviation point is identified by iterating along the second time-series signal in a reverse temporal direction to identify the point in time where the second time-series signal crosses the first envelope.

13. The computer-implemented method of claim 1 wherein the deviation point is identified using a piecewise operation.

14. The computer-implemented method of claim 1 wherein the first envelope is based on a standard deviation calculated from datapoints within the substantially stationary portion of the second time-series signal.

15. The computer-implemented method of claim 14 wherein the first envelope corresponds to a Bollinger Band.

16. The computer-implemented method of claim 1 wherein the second time-series signal corresponds to a derivative of the first time-series signal.

17. The computer-implemented method of claim 16 wherein the derivative of the first time-series signal is calculated using a finite difference method.

18. A device comprising one or more processors and a memory storing instructions which, when executed by the one or more processors, cause the device to carry out the steps of:
obtaining a first time-series signal having a first sequence of data points within a time window, the first time-series signal comprising a transition event having a deviation point;
determining a second time-series signal having a second sequence of data points within the time window, wherein the second time-series signal is indicative of a rate of change of the first time-series signal;
identifying a substantially stationary portion of the second time-series signal;
calculating a first envelope based on the substantially stationary portion of the second time-series signal, wherein the first envelope is defined across the time window; and
identifying the deviation point within the first time-series signal based on a point in time where the second time-series signal crosses the first envelope.

19. The device of claim 18 wherein the steps further include:
causing control of a controllable system based on the deviation point.

20. A non-transitory computer readable medium comprising instructions which, when executed by one or more processors, cause the one or more processors to perform the steps of:
obtaining a first signal comprising a transition event having a transition start point;
determining a first transformed signal such that the first transformed signal is indicative of a rate of change of the first signal;
calculating a first envelope based on a substantially stationary portion of the first transformed signal; and
identifying the transition start point within the first signal based on a point in time where the first transformed signal crosses the first envelope.
